(19) United States
(12) Patent Application Publication
(10) Pub. No.: US 2015/0030262 A1
(43) Pub. Date: Jan. 29, 2015

(54) BAG WITH PRE-APPLIED STRAP HANDLE

(71) Applicant: JASA PACKAGING SYSTEMS B.V., BS Alkmaar (NL)

(72) Inventors: Hendrik, Jan Van Den Berg, Hoofddorp (NL); Petrus, Clemens, Maria Pannekeet, Bergen NH (NL); Sandra Pannekeet, Alkmaar (NL)

(73) Assignee: OTIUM PACKAGING TECHNOLOGY BV, Zuid-Scharwoude (NL)

(21) Appl. No.: 14/369,400

(22) PCT Filed: Dec. 27, 2012
(86) PCT No.: PCT/EP2012/076992

§ 371 Date: Jun. 27, 2014

(30) Foreign Application Priority Data
Dec. 27, 2011 (NL) 2008045

(51) Int. Cl. B65D 33/10; B31B 1/86

(52) U.S. Cl. CPC B65D 33/105; B31B 1/86
USPC 383/29; 493/226

(57) ABSTRACT

A method for forming a bag with a carrying handle from a continuous web of flexible material is described. The handle has an inactivated position, in which it extends substantially in a cross machine direction of the web, and an activated or in-use position, substantially perpendicular to the inactivated position. The method permits attachment of the handles to the web before the bag is formed, without a risk of inadvertently cutting the handle. The activated position of the handle provides optimum force distribution among the materials of the bag, thus minimizing or eliminating the need for using reinforcement materials.

### BACKGROUND OF THE INVENTION

1. Field of the Invention

The invention relates generally to a bag made of a flexible material. The bag is provided with at least one strap handle, which is applied to the flexible material before the bag is fully formed. The invention further relates to a method for forming the bag; to a continuous web of flexible material for use in manufacturing the bag; and to a continuous web of strap material for use in forming the handles.

2. Description of the Related Art

Bags made of a flexible material are used extensively for packaging a wide variety of products. Many types of flexible material are being used for this purpose, such as paper, plastic film, plastic mesh, combinations of plastic film and plastic mesh, flexible laminate materials, and the like.

To reduce the cost of flexible bags it is desirable to form the bags on a machine, preferably from one or more continuous webs of flexible material. In addition, it is important to operate the bag-forming machine at as high a speed as possible, and to reduce the amount of down time of the machine. Furthermore, for environmental as well as cost reasons, it is desirable to limit the amount of flexible material used in making the bag.

In many cases it is desirable to provide flexible bags with one or more carrying handles. For example, having one or more carrying handles is desirable when the product packaged in the bag exceeds a certain weight, for example 1 kg or more. Numerous products are being sold in quantities well in excess of 1 kg. Examples include agricultural products, such as potatoes, tomatoes, onions, citrus fruit, apples, and the like; household products such as laundry detergent, dishwashing tablets, salt tablets, and the like; pet care products such as dog food, cat litter, and the like; gardening products such as potting soil, mulch, fertilizer pellets, grass seed, and the like. In a wide variety of product categories there is a trend towards larger package sizes, as consumers are interested in lower prices generally associated with larger packaging sizes.

Also for smaller packaging sizes there is an increasing interest in providing carrying handles, so as to encourage on-the-go consumption of the product. Examples include nuts, trail mixes, potato chips, candy, licorice, and other types of ready-to-eat snacks.

One prior art approach to the need for providing a carrying handle on a flexible bag is to provide the top of the bag with a reinforcement strip provided with one or more holes to accommodate the fingers or the palm of the human hand. Examples of this approach are disclosed in EP 0 047 544 A1; EP 0 302 460 A1; and EP 0 788 974 A1. The need for reinforcing material considerably adds to the cost of the bag, and the reinforced material tends to cut into the hand or fingers of the person carrying the bag.

Another approach is to attach a strap handle to the bag after the bag is formed, or while the top of the bag is being sealed. Examples of this approach are disclosed in ES 2 213 432 A1; U.S. Pat. No. 4,795,268; WO 03/045802; US 2001/0049924; and EP 1 176 104 A2 Inherent to this approach is that the handle can only be attached to the bag at the very end of the bag forming process, or after the bag is fully formed and sealed. The handle is attached to the top seal of the bag, which generally requires that the top seal is provided with a reinforcing material.

Methods have been proposed in which handles are attached to a continuous web of flexible material before the bags are formed. U.S. Pat. No. 5,609,556 discloses a process wherein U-shaped handles are applied to paper bags. The handles are folded back so as to avoid their sticking out during the stacking process. The described method requires two handles to be applied to each bag.

DE OS 36 34 238 A1 and WO 2010/106567 A1 disclose methods whereby strips of handle material are applied to the center of a continuous web of flexible material. After a strip is applied the web is folded and a gusset is formed. The method can only be used on machines forming bags with side seals. The resulting handle is positioned tightly against the bag when the bag is full.

Thus, there is a particular need for a method for forming a bag with at least one carrying handle from a continuous web of flexible material that can be used on a wide variety of bag forming machines, in particular form-fill-seal machines. There is a further need for a method in which the carrying handle can be attached to the flexible material before the bag is formed. There is a further need for providing a bag in which the carrying handle or handles is/are attached to the front and rear panels of the bag and run across a top seal of the bag.

### BRIEF SUMMARY OF THE INVENTION

The present invention addresses these problems by providing a method for forming a bag with carrying handle from a continuous web of flexible material, said web having a machine direction and a cross-machine direction, said handle, when it is in use, having an activated position generally extending in the machine direction of the web, said method comprising the steps of:

a. adhering to the web a strip of handle material at two attachment points, such that a central portion of the strip between the two attachment points extends substantially in the cross machine direction of the web, corresponding to an inactivated position of the handle;

b. forming a bag by forming seals at predetermined locations in the web;

c. separating the bag from the continuous web by applying cuts in the cross-machine direction of the web.

In a preferred embodiment the invention provides a method for forming a bag with carrying handle from a continuous web of flexible material, said web having a machine direction and a cross-machine direction, and having a width W in the cross machine direction, said method comprising the steps of:

a. adhering to the web a strip of handle material at two attachment points, such that the two attachment points are separated by a distance in the cross machine direction substantially equal to 0.5 W;

b. forming a bag by forming seals at predetermined locations in the web;

c. separating the bag from the continuous web so that at least one edge of the bag is located at a distance of less than 0.25 W from at least one of the attachment points of the strip of handle material.

The handle material may be adhered to the continuous web of flexible material in a bag forming machine, just before the bag is formed. Alternatively the handle material may be applied to the web before the web is supplied to the bag forming machine. For example, the handle material may be applied to the web by the manufacturer of the flexible material, to be shipped to the packaging facility as, for example, a roll stock.

Another aspect of the invention comprises a continuous web of flexible material for use in the method of the invention.

Yet another aspect of the invention comprises a web of handle material or a plurality of pre=cut handle straps for use in the method of the invention.

Yet another aspect of the invention comprises a bag made by the method of the invention.

### BRIEF DESCRIPTION OF THE DRAWINGS

The features and advantages of the invention will be appreciated upon reference to the following drawings, in which:

FIG. 1 is a schematic top view of a continuous web with handle straps attached thereto.

FIG. 1B is a schematic top view of a continuous web with handle straps attached in a non-symmetrical fashion.

FIG. 2 is a schematic top view of a continuous web comprising strips of plastic foil and strips of a net material, with handle straps attached to the strips of plastic foil.

FIG. 3 is a schematic perspective view of a tube formed from the continuous web of FIG. 1 or FIG. 2.

FIG. 4A is a front view of a finished bag with inactivated handle. FIG. 4B is a front view of a finished bag with activated handle.

FIG. 5A is an embodiment of a continuous web having strips of handle material located in the center of the web. FIG. 5B is a top view of a tubular form made from the web of FIG. 5A.

FIG. 6B is an embodiment of a continuous web having strips of handle material in staggered locations. FIG. 6A is a top view of a tubular form made from the web of FIG. 6B. FIG. 6C is a schematic view of a bag made from the web of FIG. 6B.

FIG. 7 shows an embodiment of a bag with a front opening and a handle, made by the method of the invention.

FIG. 8A shows a continuous web having pre-attached twisted handles. FIG. 8B shows a bag made from the continuous web of FIG. 8A.

### DETAILED DESCRIPTION OF THE INVENTION

The following is a detailed description of the invention.

In its broadest aspect the present invention relates to a method for forming a bag with a carrying handle from a continuous web of flexible material. The flexible material can be any material suitable for packaging purposes. Examples include paper, synthetic polymers, biodegradable polymers, as well as laminates of such materials. The flexible material can be in the form of a sheet, a film, a fabric, a scrim, a mesh, and the like. It will be understood that the web can comprise strips of different materials. For example, agricultural products are oftentimes packaged in bags made of a combination of a net material and a plastic film. The net material provides air circulation, and the plastic film provides reinforcement, as well as presenting a suitable surface for printing.

The term “continuous web” means a web of flexible material of sufficient size for forming a plurality of bags. The web can have a flat configuration, or it can be in the form of a tube. The web is typically provided rolled up on a spool. The flexible material can be fed into a bag forming machine by unrolling the web from the spool.

Strips of a handle material are attached to the web prior to the formation of the bags. The strips may be attached to the web just prior to the formation of the bags, for example on the machine that forms the bag. Or the strips may be attached to the web before the web is fed into the bag forming machine, for example on a separate machine that is located just upstream of the bag forming machine. Alternatively the strips may be attached to the web by a machine that is in a different location from the bag making machine, for example at the premises of the manufacturer of the web.

The web has a machine direction, which is the vector in the plane of the web that corresponds to the direction of travel of the flexible material in the bag forming machine. The cross-machine direction is the vector perpendicular to the machine direction in the plane of the web. The dimension of the web from edge to edge in the cross-machine direction will be referred to as the width “W” of the web. In the case of a tubular web the width W corresponds to the circumference of the tube.

An important step in the method of the invention consists of adhering to the web a strip of handle material. The handle material can be the same as or different from the flexible material from with the bag proper is to be formed. In general the handle material must be stronger than the flexible material. The handle material can consist, for example, of two or more plies of the flexible material, with the number of plies being selected to provide the desired strength.

In an embodiment of the invention the handle material is different from the flexible material. Suitable examples include strips of synthetic plastic material, optionally reinforced with a fabric, such as a cotton or nylon fabric; multiple plies of a paper stock, such as Kraft paper, and the like. It can be advantageous to provide the handle material in a color that is different from the color of the flexible material. The color of the handle can be used to identify the manufacturer, or the supermarket chain where the bag is to be sold. In another embodiment the color of the handle can be used to identify the product in the bag, for example green for grass seed; black for potting soil; yellow for nitrogen-rich fertilizer; pink for potassium-rich fertilizer; etc. It will be understood that the handle material can be imprinted with a repeating pattern showing the logo of the manufacturer or the retailer.

The strap material can have a width suitable for its purpose. For example, for heavy bags the width may be in the range of 15 to 50 mm. For lighter bags, such as lifestyle carry bags, the width of the strap can be much smaller, for example 5 to 15 mm.

As bags are being formed from the continuous web, the process comprises a cutting action whereby individual bags are separated from the web. Importantly, during the cutting action the strips of handle material extend in a direction that is substantially parallel to the cutting direction. For example, if the cutting direction is the cross-machine direction of the web (as will usually be the case), the strips of handle material extend substantially in the cross-machine direction of the web, so that the strips are not inadvertently cut. In use, however, the strap handles extend in the machine direction of the web, for optimum force distribution.

The strip of handle material is attached to the continuous web at two points, which in a preferred embodiment are separated by a distance in the cross machine direction substantially equal to one half of the width W (0.5 W) of the web. The attachment “points” are not points in the mathematical sense of not having any surface area. The attachment points are large enough to provide sufficient adhesive strength to the handle. The distance in the cross machine direction between the two attachment points is measured from the center of the first attachment point to the center of the second attachment point.

As will be explained in more detail below, the distance between the two attachment points can be somewhat less than 0.5 W. In the case of a flat web, part of the width W will be used for providing a longitudinal seal, so that the circumference of the tube formed from the web is somewhat less than W. The distance between the two attachment points of the handle is desirably selected to correspond to one half of the circumference of the resulting tube, and therefore will be slightly less than 0.5 W. It will be clear to the skilled person how to make this adjustment. The corresponding spacing of the two attachment points is considered to be within the meaning of “substantially equal to 0.5 W”.

In another embodiment each bag is provided with two parallel handles. For this embodiment two strips of handle material are placed side-by-side on the continuous web. Each strip is attached at two attachment points, which are spaced form each other by somewhat less than 0.5 W. This is still considered to fall within the definition of “substantially equal to 0.5 W.”

In yet another embodiment, subsequent strips of handle material are placed in a staggered pattern, so as to permit rolling the web onto a spool. In this embodiment the spacing of the two attachment points needs to be less than 0.5 W. This is still considered to fall within the definition of “substantially equal to 0.5 W.” In general, any spacing in the range of from 0.4 W to 0.6 W is considered to be substantially equal to 0.5 W.

The strip of handle material extends in the cross machine direction of the web before the bag is formed and during the forming process of the bag. In use the handle extends in the machine direction of the web. It is desirable that the attachment points extend in the machine direction of the web. This can be accomplished by making two diagonal folds in the strip of handle material, so as to divide the strip into a central portion and two end portions. The length of the central portion is substantially equal to 0.5 W. The lengths of the two end portions are selected so as to provide sufficient surface area for securely attaching the strip to the continuous web. The two end portion can be of equal length, or different lengths. Desirably the end portions are attached to the web along their entire lengths. In an alternate embodiment the end portions are attached along less than their entire lengths, so that areas of the end portions proximate to the central portion are unattached to the web. This facilitates the transition of the handle from an inactivated position to an activated position, as will be explained in more detail below.

The strip of handle material can be attached to the web by any attachment means known in the art. Examples include heat welding, pressure sensitive adhesive, hot melt adhesive, ultrasonic welding, and the like. An important advantage of the present invention is that this part of the process takes place before the bag is formed, so that it is easy to apply pressure and/or heat to the end portions of the strip, while supporting the web.

In a subsequent step the web is formed into a bag by forming seals at predetermined locations in the web. This part of the method will be described with reference to a form-fill-seal machine, in particular a vertical form-fill-seal (VFFS) machine. It will be understood that the method can be used on other types of bag forming machines, although for certain types of machine the terms “machine direction” and “cross-machine direction” may have to be transposed into each other. Put differently, for certain bag making machines the handle material must be attached to extend in the machine direction before and during the bag forming process, and in the cross-machine direction during use.

On a VFFS the web is draped around a shoulder and formed into a tube along a cylindrical mandrel. The web is formed into a tube by sealing the side edges of the web to each other, in usual fashion. After the tube is formed a transverse seal is formed to define either the top or the bottom of the bag. The bag is then filled with the desired amount of product to be packaged, after which the bag is sealed at either the bottom (if the top was sealed first), or at the top (if the bottom was sealed first). The bag is then cut off from the web at the location of the last-formed seal.

The position of the strip on the handle material on the web is such that, once the bag is cut off the web, the attachment points are located such that the sum of the distances of each attachment point to the top edge of the bag is at least 0.5 W. For symmetrically placed attachment points this means they are each located at less than 0.25 W from the top edge of the bag. Preferably the attachment points are located at between 0.05 W and 0.25 W from the top edge of the bag, more preferably between 0.08 W and 0.15 W from the top edge of the bag. This location ensures that the handle extends sufficiently above the top of the bag to provide a convenient handle.

Importantly, the central portion of the strip of handle material remains extended in the cross machine direction of the web while the transverse seams are formed and while the transverse cuts are being made. The cross-machine position of the central portion of the strip prevents its becoming trapped in one of the seals, or from becoming cut during one of the cutting operations. Upon completion of the bag, the central position moves to a position in which it extends substantially in the machine direction of the web. This process is referred to as “activation” of the handle. Depending on the flexibility of the handle material and on the force that was applied to it when the diagonal folds were formed, activation of the handle may happen spontaneously.

It will be clear from the foregoing that the central portion of the strip of handle material is unadhered to the web. However, it may be desirable to temporarily adhere the central portion to the web, for example by applying one or more small beads of glue at one or more locations along the length of the central portion. Instead of using glue beads the central portion of the handle may be attached to the web by welding. In some cases bags are formed from laminate materials that are weldable on the inside of the bag, but not on the outside. In such cases the web may be provided with two parallel slits in the machine direction of the web, long enough to accommodate the width of the strap. When the strap is applied to the web it is threaded through the two slits, so that a short length of the central portion of the strap is in contact with the inside (weldable) surface of the web. If desired the strap may be welded to the web at this location. In some cases the threading through the two slits provides the desired temporary adherence.

Such temporary adherence prevents the handle from becoming activated prematurely, which could cause it to become trapped in the top seal, or to become cut when the top of the bag is cut off the web. Temporary adherence may also be desirable during transportation. The strength of the adhesion used for this purpose should be such that the handle can be easily activated when use of the handle is desired.

The first step of the process, i.e., attachment of the strip of handle material to the continuous web, may be carried out in the bag forming machine, or it may be carried out upstream of the bag making process, for example during the manufacture of the continuous web. In the latter case the first step is carried out in a first machine, and the subsequent steps of forming the bag and separating the bag from the web, are carried out in a second machine. The first machine may produce rolls of web material having attached to it strips of handle material at predetermined intervals. The second machine can be a horizontal form-fill-seal machine (HFFS) or a vertical form-fill-seal machine (VFFS), or some other type of bag forming machine. For HFFS machines the web is typically provided in the form of a tube.

As noted earlier, it is possible to carry out all three steps in one machine. Such machine can be a standard bag forming machine, to which a module is added for preparing the strips of handle material and for attaching these strips to the web.

The continuous web of flexible material may comprise strips of different material.

For example, bags for agricultural product may comprise strips of plastic foil and strips of net material. As disclosed in U.S. Pat. No. 7,356,972 B2 to Pannekeet, the individual strips of material can be combined within the bag forming machine. The strip of handle material can be attached to one of the strips before the strips are adhered to each other. Preferably, however, the strips are adhered to each other first, and the handle strips are adhered to different strips within the web. Specifically, it is desirable to adhere the handle strips to two parallel strips of film material of the web, so as to bridge an area of net material.

Another aspect of the invention is a web of handle material for use in the method. The web can be a roll of material having the desired width of the handle. The web can also be wider than the desired width of the handle. In the latter case, strips of handle material are formed from the web by splitting the web along longitudinal lines. Conveniently, the handle material is provided with adhesive in predetermined locations, corresponding to the areas of the intended end portions of the strips of handle material to be adhered to the web. Adhesive can be applied in any form, for example hot melt adhesive, pressure-sensitive adhesive, double-side tape, etc. The adhesive may be covered with a liner, such as silicone paper, to prevent contamination of the adhesive and premature sticking of the adhesive.

In an alternate embodiment strips of handle material can be provided pre-cut. For example, a cassette containing pre-cut strips of handle material may be configured to supply individual strips to a bag forming machine or to a web forming machine, for equidistant attachment to the web.

Another aspect of the invention is a continuous web for use in steps b. and c. of the above-described process. Such web has a machine direction and a cross-machine direction, and has a width W in the cross machine direction. Adhered to the web are individual strips of handle material, each strip being adhered to the web at two attachment points. The two attachment points of each strip are separated by a distance in the cross machine direction substantially equal to 0.5 W. The meaning of the term “substantially equal to 0.5 W” is as defined herein above.

Individual strips are spaced from each other in the machine direction by a distance corresponding to the intended length of the bags to be formed from the web. In an alternate embodiment the individual strips are spaced by a distance equal to the width of the bags to be formed form the web.

The web can have markers that define cutting locations for separating each bag, once it is formed, from the web. The markers each define one cutting location that is spaced less than 0.25 W from the two attachment points of a strip of handle material, preferably between 0.05 W and 0.25 W from these two attachment points, more preferably between 0.08 W and 0.15 W.

It is desirable to place the strips on the web so that the web may be rolled onto a spool. In general this can be accomplished by placing the strips symmetrically relative to the longitudinal center line of the web. In an alternate embodiment the strips are placed in staggered locations, such that each strip extends entirely on one side of the longitudinal center of the web, and that equal numbers of strips are located to each side of the longitudinal center.

The web can comprise a plastic film material, a net material, paper, or a combination thereof. In a particular embodiment the web comprises paper and a biodegradable polymer, for example in the form of a laminate. In another embodiment the web comprises a plastic film material and a web material. The web of the latter embodiment is particularly suitable for packaging agricultural products.

The thickness, or gauge, of the material used for the web depends on a number of factors, such as the type of material used (paper; laminate; low density polyethylene (LDPE); high density polyethylene (HDPE); polypropylene (PP), and the like); the intended weight of the contents of the bag; the desired appearance of the bag; etc. Importantly, it has been found that the use of the strap handles do not require a reinforcement material, which represents a significant cost saving as compared to bags with a hand grip or finger grips in the top seal, which do require a significant amount of reinforcement material. By way of example, a bag intended for 5 kilograms of material can be made from a PE film having a thickness in the range of 40 to 70 μm, without requiring reinforcement in the attachment areas of the handle.

In yet another aspect the invention relates to bags made by the method of the invention. Such bags are characterized by having at least one handle strap that was attached to the bag material prior to formation of the bag. The at least one handle strap extends from a front panel of the bag, across a top opening or a top seal of the bag, to a rear panel of the bag.

The strap handle has two end portions and a central portion. The two end portions are adhered to the bag, respectively to the front panel and the rear panel. The central portion is substantially unadhered to the bag. The length of the central portion is substantially equal to one half of the circumference C of the bag. “Substantially equal to 0.5 C” means between 0.4 C and 0.6 C. The distance from each end portion to the top seal of the bag or to the top opening of the bag is less than 0.25 C, preferably between 0.05 C and 0.25 C, more preferably between 0.08 C and 0.15 C.

An important aspect of the bags of the present invention is that a handle is attached to two opposing panels, and bridges a top edge or a top seal of the bag. In other words, even though the handle was attached to the web before the bag was formed, the handle bridges a line along which the web was cut. This has been made possible by the feature of the invention according to which the handle extends in a first direction during the cutting, and in a second direction during use, the first direction being substantially parallel to the cutting direction, and the second direction being substantially perpendicular to the first direction.

### DESCRIPTION OF ILLUSTRATIVE EMBODIMENTS/EXAMPLES

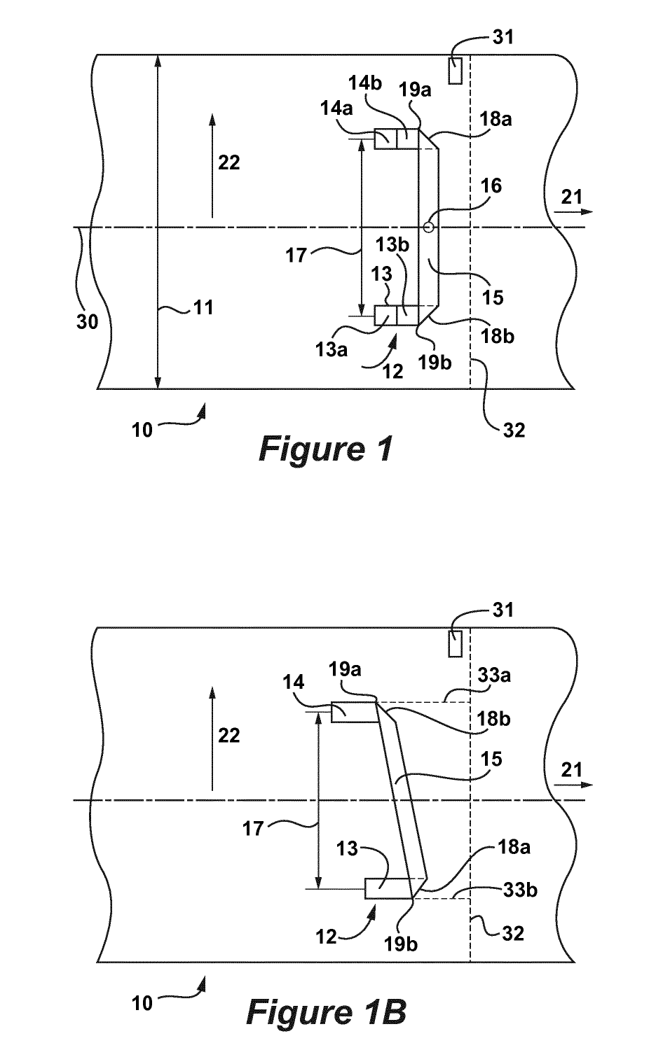

The following is a description of certain embodiments of the invention, given by way of example only and with reference to the drawings. Referring to FIG. 1, a continuous web 10 is shown. Web 10 has a machine direction indicated by arrow 21, and a cross-machine direction indicated by arrow 22. Web 10 has a cross-machine direction width W, indicated by double arrow 11. It will be understood that the machine direction could also be at an angle of 180° from the direction shown in FIG. 1.

Attached to web 10 is a strip of handle material 12. Diagonal folds 18a and 18b divide strip 12 into a first end portion 13, a second end portion 14, and a central portion 15. End portions 13 and 14 are adhered to web 10, for example by double-sided tape, welding, pressure sensitive adhesive, or hot melt adhesive. The entire end portions 13 and 14 can be adhered to web 10. In an alternate embodiment only areas 13a and 14b of end portions 13 and 14, respectively, are adhered to web 10. This leaves areas 13b and 14b free to move with central portion 15 when the handle is activated. This embodiment may be preferred for bags that do not have side gussets, such as pillow bags.

Central portion 15 is unadhered to web 10, except for a weak attachment by glue bead 16. The purpose of glue bead 16 is to prevent shifting of strip 12 during the bag forming process, and to keep the strip tight to the bag, once formed, during transportation, if desired. Glue bead 16 provides a weak bond between strip 12 and web 10, and is easily broken by a pull on the handle.

As shown in FIG. 1, the central portion 15 of strip 12 extends in the cross-machine direction of web 10. End portions 13 and 14 extend in the machine direction of web 10. In this particular embodiment the cross-machine direction distance between the centerlines of end portions 13 and 14, indicated by double arrow 17, is equal to 0.5 W. In this embodiment strip 12 is placed symmetrically with respect to center line 30 of web 10.

Web 10 carries a marker 31, which is designed to interact with a sensor on the bag forming machine. Marker 31 can be a visual marker, a u.v. marker, or any type marker suitable to cooperate with the relevant sensor on the bag forming machine. Marker 31 defines a cutting line 32, which defines the top edge of the bag, once it is formed. The machine direction distance of folding corners 19a and 19b to cutting line 32 is less than 0.25 W.

Although not shown in FIG. 1, web 10 is provided with additional handle strips 12 and additional cutting markers 31. The handle strips and the cutting markers are placed at distances from neighboring handle strips and cutting markers equal to the cutting lengths of the bags.

Web 10 in FIG. 1 can be a film of a polymeric material, such as PE, and can be opaque or transparent. Bags formed from web 10 can be used for any solid bulk products, such as wood chips; mulch; potting soil; fertilizer pellets; grass seeds; pet food; pet litter material; coarse salt crystals; salt tablets; scouring powder; detergent powder; baking soda; charcoal; etc.

FIG. 1B shows an alternate embodiment of the web of FIG. 1. Web 10 has attached thereto a strip of handle material 12. Strip of handle material 12 is attached to web 10 at end portions 13 and 14. End portions 13 and 14 extend in the machine direction 21 of web 10, but end portion 13 is closer to cutting line 32 than is end portion 14. Central portion 15 of handle strap 12 generally extends in the cross machine direction 22 of web 10, but at an angle of x° (not shown). Likewise, diagonal folds 18a and 18b are at an angle of (45-x)° and (45+x)° , respectively, of central portion 15.

In this embodiment distance 33a from fold point 19a to cutting line 32 is greater than distance 33b from fold point 19b to cutting line 32. In general, the sum of distances 33a and 33b should be less than 0.5 W. The embodiment of FIG. 1B provides flexibility to the lay-out of any printing on web 10, as it allows the positions of the attachment points to be selected in such a way as to avoid obscuring such printing.

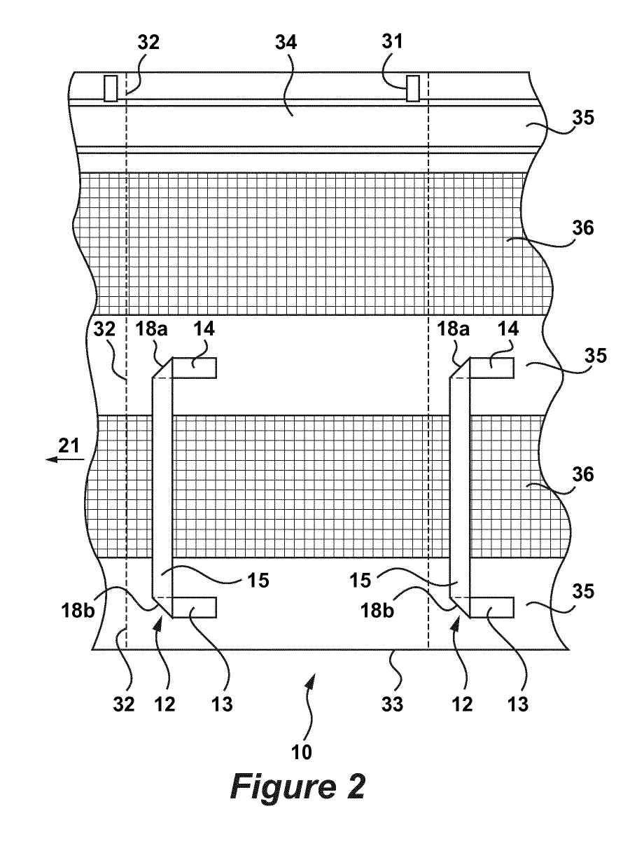

FIG. 2 shows a schematic top view of a web 10, having attached thereto strips of handle material 12. The strips 12 have diagonal folds 18a, 18b, which divide the strips into end portions 13, 14, and central portions 15. Web 10 has a first edge 33 and a second edge 34.

During the bag formation process edge 33 is secured to edge 34, for example by welding, to form a tube. In an alternate embodiment web 10 is supplied in the form of a tube, in which case the tube forming step does not take place in the bag forming machine. Web 10 carries markers 31, which define transverse cutting lines 32. If desired, one of the end portions 13, 14 can be used as a marker for defining the cutting line 32, for example if the bag is made of a transparent film.

Web 10 comprises strips 35 of a plastic foil material, and strips 36 of a plastic mesh material. Web 10 may be formed by adhering strips 35 and 36 to each other at their respective edges. Alternatively, web 10 may be formed by providing a strip of mesh material of the full width of web 10, and superimposing foil strips 35 onto the mesh material, leaving uncovered portions of mesh material 36, and foil/mesh laminate portions 35.

It will be noted that the embodiment shown in FIG. 2 is lacking glue bead 16, shown in FIG. 1. It has been found that, depending on the stiffness of the strip of handle material 12 and the sharpness of folds 18a, 18b, strip 12 may stay reliably in its intended position during the entire bag forming process, so that securing the central portion 15 is not necessary in those cases. It will be understood that securing of the central portion may still be used, for example to keep the handle close to the bag during transportation, if desired.

Bags formed from web 10 of FIG. 2 are particularly suitable for products that require some amount of ventilation during storage and handling. Examples include agricultural products, such as potatoes; onions; nuts; apples; citrus fruits, and the like.

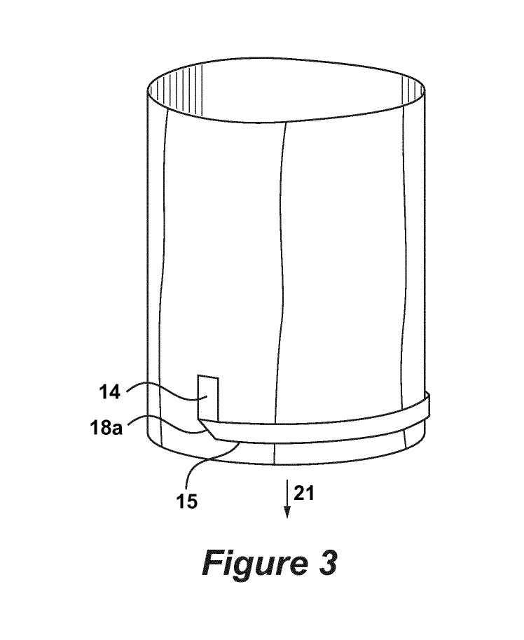

FIG. 3 shows a schematic perspective view of a tube formed from web 10 of FIG. 1 or FIG. 2. It will be understood that, unlike what's shown in FIG. 3, the tube is normally still attached to the continuous web during this stage of the bag forming process. FIG. 3 is merely intended to illustrate how central portion 15 of the handle is flush against the tube shaped web, and extends parallel to the line where the tube will later be cut.

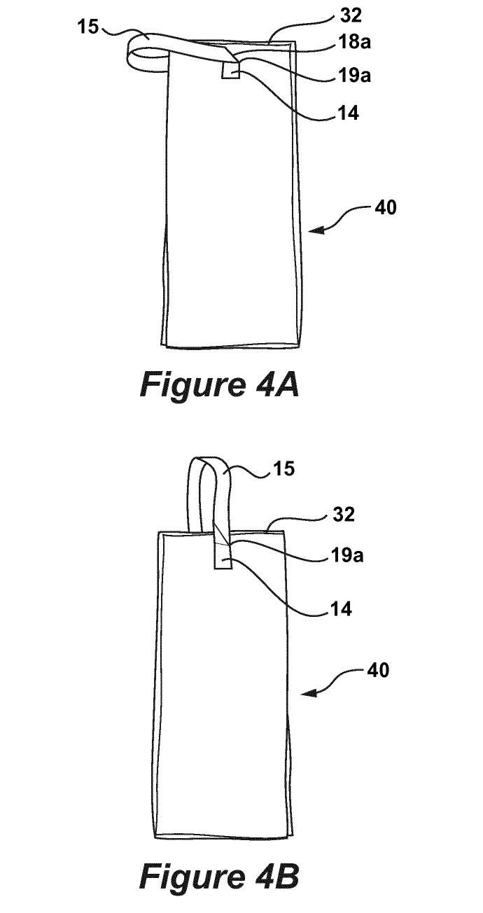

FIG. 4A shows a front view of completed bag 40. The handle is attached to the front panel of bag 40 at end portion 14. Central portion 15 extends sideways, in the cross-machine direction of the bag, in what is referred to herein as the inactivated position of the handle. Corner point 19a of diagonal fold 18a is at a distance of less than 0.25 W from top edge 32.

FIG. 4B shows a front view of bag 40, with central portion 15 of the handle pointing upward, in the machine direction of the bag. This is referred to as the activated position of the handle. In this position central portion 15 bridges line 32, along which the bag was cut off from the continuous web.

The handle is attached to the front panel of bag 40 at end portion 14, and at the rear panel of bag 40 at end portion 13 (not shown). It has been found that relatively small end portions are sufficient to provide the required strength of the handle attachments. For example, end portions having a cross-machine width of 20 mm and a machine direction length of 25 mm, attached to the bag with double-sided tape, have been found sufficient for bags intended for product weights of up to 5 kg. In addition, it is not necessary to reinforce the bag in the areas where the end portions of the handle are attached. It will be understood that reinforcement may be used, if desired. It will be understood also that the end portions can be made larger, if desired. For heavy-duty applications the end portions may be extended downward, all the way to the bottom of the bag, if necessary.

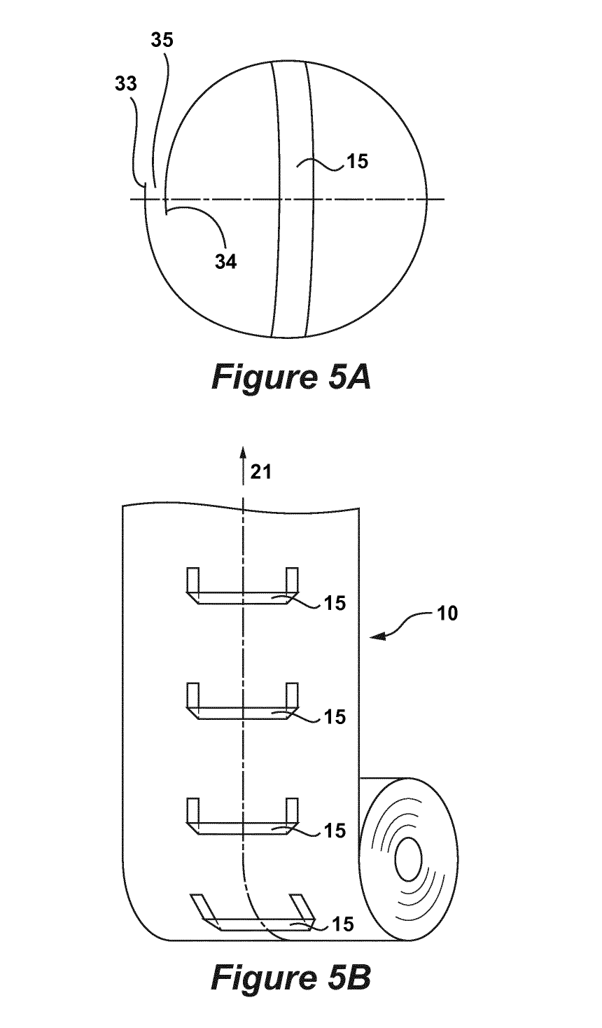

FIG. 5A shows the position of central portion 15, in activated position, relative to side edges 33 and 34, and side seam 35. The configuration of FIG. 5A results when a web is used on which the strips of handle material are attached symmetrically relative to the central line of the web 10, as shown in FIG. 5B. This central positioning of the handle strips permits web 10 to be rolled up. Being able to roll up web 10 is important in cases where web 10 is manufactured in a different location from the web forming machine, as a roll form is by far the most attractive form for handling, storing and transporting the web, and for feeding the web into a bag forming machine.

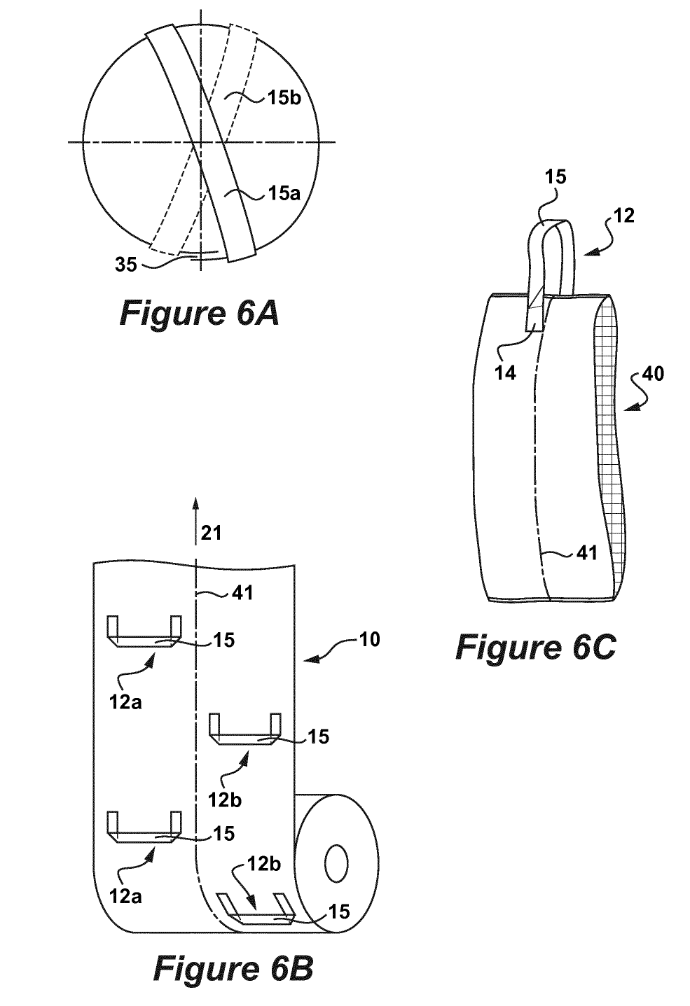

FIG. 6A shows an alternate embodiment, in which one end portion of the handle is placed more closely to side seam 35. FIG. 6B shows the web from which the bag of FIG. 6A was made. FIG. 6B shows handle strips 12a attached to web 10 entirely to the left of center line 30, and strips 12b entirely to the right of center line 30, in an alternating pattern.

This configuration permits rolling up of web 10, and the resulting roll has a smaller diameter than would result from the configuration of FIG. 5B. However, this configuration results in an asymmetric placement of handle 12 on bag 40. As shown in FIG. 6C, end portion 14 is placed to the left of center line 41, and end portion 13 on the rear panel (not shown) is attached to the right of center line 41.

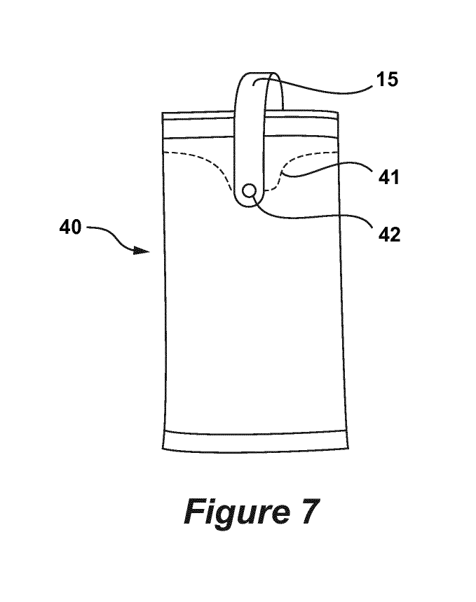

FIG. 7 shows a bag 40 that can be readily opened by tearing the front panel along line of weakness 41. The panel can be re-closed by means of push button 42. It will be understood that other forms of opening and re-closure means, such as Ziplock® are possible. The embodiment of FIG. 7 is particularly suitable for candy, nuts, and other forms of ready-to-eat snacks.

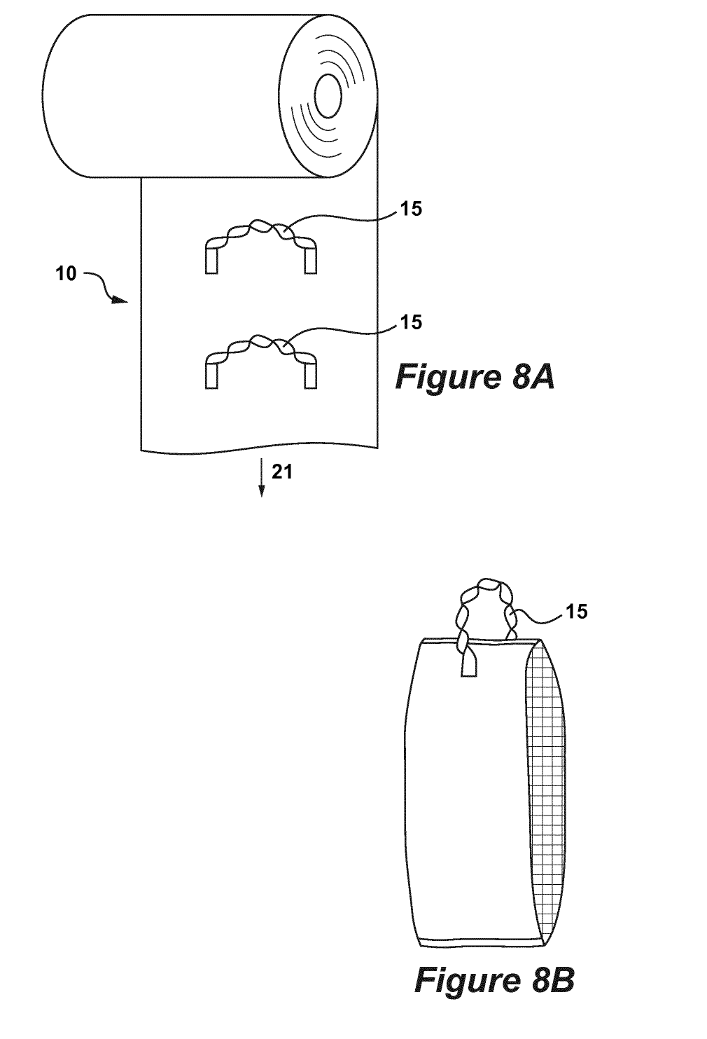

FIG. 8A shows a web 10 having attached thereto strips of handle material wherein the central portions 15 are twisted, so as to provide a more pleasing aspect. It will be understood that this is just one of very many variations that can be used to provide handles with a particular aesthetic effect. For example, the handle can be made of a material with a pattern of punched holes, to present a lace-like appearance. The shape of the handle can be flared inwardly or outwardly towards the center, etc.

Thus, the invention has been described by reference to certain embodiments discussed above. It will be recognized that these embodiments are susceptible to various modifications and alternative forms well known to those of skill in the art. In particular, the invention can be used on bag forming machines other than form-fill-seal machines.

Accordingly, although specific embodiments have been described, these are examples only and are not limiting upon the scope of the invention.

1. A method for forming a bag with carrying handle from a continuous web of flexible material, said web having a machine direction and a cross-machine direction, said handle, when it is in use, having an activated position generally extending in the machine direction of the web, said method comprising the steps of:
a. adhering to the web a strip of handle material at two attachment points, such that a central portion of the strip between the two attachment points extends substantially in the cross machine direction of the web corresponding to an inactivated position of the handle;
b. forming a bag by forming seals at predetermined locations in the web;
c. separating the bag from the continuous web by applying cuts in the cross-machine direction of the web.

2. The method of claim 1 wherein the continuous web has a width W in the cross-machine direction, and the two attachment points are separated by a distance in the cross machine direction substantially equal to 0.5 W, and at least one of the cuts applied in step is located such that the sum of distances from each attachment point of the strip of handle material to the cut is less than 0. 5 W.

3. The method of claim 1 wherein the strip of handle material comprises two diagonal folds dividing the strip into a central portion and two end portions, and attaching the strip to the web such that the central portion of the strip extends in the cross-machine direction of the web, and the two end portions extend in the machine direction of the web.

4. The method of claim 3 wherein the two end portions are substantially entirely adhered to the continuous web.

5. The method of claim 1 wherein the continuous web of flexible material comprises a plastic film, a net material, paper, or a combination thereof.

6. The method of claim 1 wherein the continuous web of flexible material comprises paper and/or a biodegradable polymer.

7. The method of claim 1 wherein step a. is carried out on a first machine, and steps b. and c. are carried out on a second machine.

8. The method of claim 7 wherein the first machine produces rolls of web material having attached to it strips of handle material at predetermined intervals.

9. The method of claim 7 wherein the second machine is a vertical form-fill-seal (VFFS) or a horizontal form-fill-seal (HFFS) machine.

10. The method of claim 1 wherein steps a., b., and c. are carried out in one machine.

11. The method of claim 10 wherein the one machine is a vertical form-fill-seal (VFFS) or a horizontal form-fill-seal (HFFS) machine.

12. The method of claim 9 wherein the continuous web of flexible material comprises a net material and a plastic film material.

13. The method of claim 12 wherein the bag is filled with an agricultural product.

14. A web of handle material or individual strips of handle material for use in the method of claim 1.

15. The handle material of claim 13 having adhesive applied thereto in predetermined locations.

16. A continuous web of flexible material for use in steps b. and c. of the method of claim 1, said web having a machine direction and a cross-machine direction, and having attached thereto a strip of handle material at two attachment points, such that a central portion of the strip between the two attachment points extends substantially in the cross machine direction of the web corresponding to an inactivated position of the handle.

17. The continuous web of claim 16 having a width W in the cross-machine direction, said attachment points being separated by a distance in the cross-machine direction substantially equal to 0.5 W.

18. The continuous web of claim 16 wherein individual strips of handle material are equidistantly spaced by a distance corresponding to the intended length of the bags to be formed from the web.

19. The continuous web of claim 16 wherein individual strips of handle material are equidistantly spaced by a distance corresponding to the intended width of the bags to be formed from the web.

20. The continuous web of claim 16 having markers defining cutting locations for separating a bag, once formed, from the web, the cutting locations being defined at a distance of less than 0.25 W from the two attachment points.

21. The continuous web of claim 16 wherein the strips of handle material are placed symmetrically relative to the longitudinal center of the web, to enable storage and transportation of the web on a roll.

22. The continuous web of claim 16 wherein the strips of handle material are placed in staggered locations, to enable storage and transportation of the web on a roll.

23. The continuous web of flexible material of claim 16 comprising a plastic film, a net material, paper, or a combination thereof.

24. The continuous web of flexible material of claim 16 comprising paper and/or a biodegradable polymer.

25. The continuous web of flexible material of claim 16 use in a vertical form-fill-seal machine (VFFS) or a horizontal form-fill-seal machine (HFFS).

26. The continuous web of flexible material of claim 25 comprising a mesh material and a plastic film material.

27. The continuous web of flexible material of claim 26 for use in packaging an agricultural product.

28. A bag made by the process of claim 1.

29. The bag of claim 28 having a handle bridging a top edge or a top seam of the bag.
